(19) United States
(12) Patent Application Publication
(10) Pub. No.: US 2023/0002610 A1
(43) Pub. Date: Jan. 5, 2023

(54) IMPACT-RESISTANT POLYESTER MATERIAL

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Yueh-Shin Liu, Taipei City (TW)

(21) Appl. No.: 17/718,269

(22) Filed: Apr. 11, 2022

(30) Foreign Application Priority Data
Jun. 30, 2021 (TW) 110123909

(51) Int. Cl. C08L 67/08

(52) U.S. Cl. CPC C08L 67/08; C08L 2666/66; C08L 2666/04; C08L 2205/08

(57) ABSTRACT

An impact-resistant polyester material is provided, which includes a polyester resin matrix material, a toughening agent and a compatibilizing agent. The toughening agent and the compatibilizing agent are dispersed in the polyester resin matrix material. The toughening agent is a polyolefin elastomer (POE). The compatibilizing agent is configured to assist in improving compatibility between the toughening agent and the polyester resin matrix material. The compatibilizing agent is at least one of a polyolefin elastomer grafted with glycidyl methacrylate (POE-g-GMA) and a polyolefin elastomer grafted with maleic anhydride (POE-g-MAH). The compatibilizing agent is configured to assist the toughening agent to be dispersed into the polyester resin matrix material with a particle size between 0.5 micrometers and 1.5 micrometers, so that the impact-resistant polyester material has an impact strength of not less than 20 kg-cm/cm.

### CROSS-REFERENCE TO RELATED PATENT APPLICATION

This application claims the benefit of priority to Taiwan Patent Application No. 110123909, filed on Jun. 30, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester material, and more particularly to an impact-resistant polyester material.

### BACKGROUND OF THE DISCLOSURE

In order to improve an impact strength of a polyester material, a direct polymerization method or an additive modification method is usually adopted in the related art.

In the direct polymerization method, long carbon segments (such as polyols) are introduced into a composition, and a polyester elastomer is directly polymerized. However, a manufacturing cost of the direct polymerization method is high, and a manufactured material has low rigidity, which cannot meet requirements of toughness and rigidity.

In the additive modification method, a modifier is added to the polyester material. For example, an acrylic elastomer or the polyester elastomer is used as an impact modifier. However, an intrinsic toughness of these elastomers is low. As such, these elastomers have a limited effect on improving the impact strength of the polyester material. Although adding a large amount of these elastomers can improve the impact strength, the manufacturing cost will be increased.

### SUMMARY OF THE DISCLOSURE

In response to the above-referenced technical inadequacies, the present disclosure provides an impact-resistant polyester material.

In one aspect, the present disclosure provides an impact-resistant polyester material, which includes a polyester resin matrix material, a toughening agent and a compatibilizing agent. The toughening agent and the compatibilizing agent are dispersed in the polyester resin matrix material. The toughening agent is a polyolefin elastomer (POE). The compatibilizing agent is configured to assist in improving a compatibility between the toughening agent and the polyester resin matrix material. The compatibilizing agent is at least one of a polyolefin elastomer grafted with glycidyl methacrylate (POE-g-GMA) and a polyolefin elastomer grafted with maleic anhydride (POE-g-MAH). The compatibilizing agent is configured to assist the toughening agent to be dispersed into the polyester resin matrix material with a particle size between 0.5 micrometers and 1.5 micrometers, so that the impact-resistant polyester material has the impact strength of not less than 20 kg-cm/cm.

Preferably, based on a total weight of the impact-resistant polyester material being 100 wt. %, a content range of the polyester resin matrix material is between 70 wt. % and 95 wt. %, a content range of the toughening agent is between 5 wt. % and 15 wt. %, and a content range of the compatibilizing agent is between 2 wt. % and 15 wt. %.

Preferably, based on the total weight of the impact-resistant polyester material being 100 wt. %, the content range of the polyester resin matrix material is between 70 wt. % and 90 wt. %, the content range of the toughening agent is between 7 wt. % and 10 wt. %, and the content range of the compatibilizing agent is between 2 wt. % and 5 wt. %.

Preferably, the content range of the toughening agent is not less than the content range of the compatibilizing agent, and a weight ratio of the toughening agent relative to the compatibilizing agent ranges from 1:1 to 4:1.

Preferably, the impact-resistant polyester material further includes: an antioxidant and a slip agent dispersed in the polyester resin matrix material. Based on the total weight of the impact-resistant polyester material being 100 wt. %, a content range of the antioxidant is between 0.1 wt. % and 1.0 wt. %, and a content range of the slip agent is between 0.1 wt. % and 1.0 wt. %.

Preferably, a molecular structure of the toughening agent is all polyolefin elastomer (POE), a molecular structure of the compatibilizing agent has a main chain and a side chain, and the main chain is the polyolefin elastomer (POE).

Preferably, the compatibilizing agent is further defined as a polyolefin elastomer grafted with glycidyl methacrylate (POE-g-GMA), the molecular structure of the compatibilizing agent has a main chain and a side chain melt-grafted with the main chain, the main chain is the polyolefin elastomer (POE), and the side chain is the glycidyl methacrylate (GMA). The glycidyl methacrylate is able to produce a ring-opening reaction during a mixing process, and an epoxy group in the glycidyl methacrylate is able to chemically react with an ester group in a molecular structure of the polyester resin matrix material after the ring-opening reaction, so that the toughening agent is dispersed in the polyester resin matrix material.

Preferably, the polyester resin matrix material has a first melt flow index, and the toughening agent has a second melt flow index. The first melt flow index of the polyester resin matrix material is between 55 g/10 min and 65 g/10 min, and the second melt flow index of the toughening agent is between 75% and 125% of the first melt flow index of the polyester resin matrix material.

Preferably, the polyester resin matrix material is a continuous phase, the toughening agent is a dispersed phase dispersed in the continuous phase. The dispersed phase and the continuous phase interact with each other, so that a material surface of the impact-resistant polyester material forms a sea-island structure.

Preferably, the impact-resistant polyester material meets at least one of following conditions: (i) having an impact strength between 20 kg-cm/cm and 50 kg-cm/cm; (ii) having a density between 1.15 g/cm³ and 1.30 g/cm³; (iii) having a tensile strength between 38 MPa and 50 MPa; (iv) having a bending strength between 65 MPa and 75 MPa; (v) having a bending modulus between 1,800 MPa and 2,200 MPa; (vi) having a heat distortion temperature between 55° C. and 80° C.; (vii) having a shrinkage between 0.7-1.0; and (viii) having an HB rating in a UL94 plastic flammability standard.

Therefore, in the impact-resistant polyester material provided by the present disclosure, by virtue of “the toughening agent being dispersed in the polyester resin matrix material, and the toughening agent being a polyolefin elastomer (POE)”, “the compatibilizing agent being dispersed in the polyester resin matrix material, the compatibilizing agent being configured to assist in improving compatibility between the toughening agent and the polyester resin matrix material, and the compatibilizing agent being at least one of a polyolefin elastomer grafted with glycidyl methacrylate (POE-g-GMA) and a polyolefin elastomer grafted with maleic anhydride (POE-g-MAH)”, and “the compatibilizing agent being configured to assist the toughening agent to be dispersed into the polyester resin matrix material with a particle size between 0.5 micrometers and 1.5 micrometers”, an impact strength of the polyester material can be greatly improved, thereby enhancing the application value of the polyester material.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an impact-resistant polyester material according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

[Impact-Resistant Polyester Material]

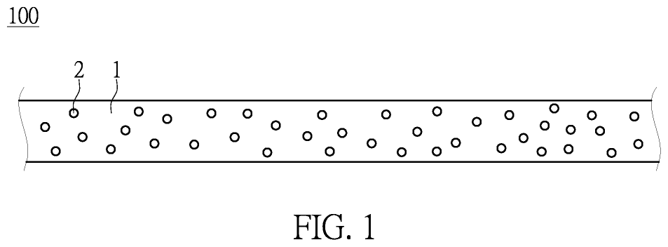

Referring to FIG. 1, an embodiment of the present disclosure provides an impact-resistant polyester material 100, and the impact-resistant polyester material 100 includes a polyester resin matrix material 1, a toughening agent 2 (also called an impact-resistant modifier), and a compatibilizing agent (not labeled in the drawings).

One of the objectives of the present disclosure is to improve compatibility between the toughening agent 2 and the polyester resin matrix material 1 and to improve dispersibility of the toughening agent 2 in the polyester resin matrix material 1. Therefore, the impact-resistant polyester material 100 of the present embodiment can have a relatively high impact strength. For example, the impact strength of a conventional polyester material is not greater than 5 kg-cm/cm. In contrast, the impact strength of the impact-resistant polyester material 100 of the present embodiment can be greatly increased to not less than 20 kg-cm/cm, and preferably between 30 kg-cm/cm and 48 kg-cm/cm.

The impact-resistant polyester material 100 of the embodiment of the present disclosure can replace plastic materials, such as acrylonitrile-butadiene-styrene (ABS), polycarbonate (PC), and polypropylene (PP), and be applied to injection or extrusion parts with high impact resistance requirements (e.g., luggage cases, safety helmets, electronic casings, food trays, and electronic and automotive decorative films).

The polyester material is polyethylene terephthalate (PET) or polyethylene naphthalate (PEN). Particularly preferably, the polyester material is polyethylene terephthalate (PET), but the present disclosure is not limited thereto.

In the present embodiment, the polyester resin matrix material 1 is a matrix material of the impact-resistant polyester material 100. The polyester resin matrix material 1 is a high molecular weight polymer obtained by a condensation polymerization reaction of a dibasic acid and a diol or a derivative thereof. In other words, the polyester resin matrix material 1 is a polyester material. Preferably, the polyester material is polyethylene terephthalate (PET) or polyethylene naphthalate (PEN). More preferably, the polyester material is polyethylene terephthalate (PET), but the present disclosure is not limited thereto.

In terms of content range, based on a total weight of the impact-resistant polyester material 100, a content range of the polyester resin matrix material 1 is preferably between 70 wt. % and 95 wt. %, and more preferably between 70 wt. % and 90 wt. %. It should be noted that the term “substrate material” or “matrix material” as used herein refers to a material whose content occupies at least half of a composition.

The above-mentioned dibasic acid used for forming the polyester material is at least one of terephthalic acid, isophthalic acid, 1,5-naphthalenedicarboxylic acid, 2,6-naphthalenedicarboxylic acid, 1,4-naphthalenedicarboxylic acid, bibenzoic acid, diphenylethane dicarboxylic acid, diphenyl dicarboxylic acid, anthracene-2,6-dicarboxylic acid, 1,3-cyclopentane dicarboxylic acid, 1,3-cyclohexane dicarboxylic acid, 1,4-cyclohexane dicarboxylic acid, malonic acid, dimethylmalonic acid, succinic acid, diethyl 3,3-succinate, glutaric acid, 2,2-dimethylglutaric acid, adipic acid, 2-methyl adipic acid, trimethyladipic acid, pimelic acid, azelaic acid, sebacic acid, suberic acid, and dodecanedioic acid. Preferably, the dibasic acid is terephthalic acid.

Furthermore, the above-mentioned diol used for forming the polyester material is at least one of ethylene glycol, propylene glycol, hexamethylene glycol, neopentyl glycol, 1,2-cyclohexanedimethanol, 1,4-cyclohexanedimethanol, 1,10-decanediol, 1,3-propanediol, 1,4-butanediol, 1,5-pentanediol, 1,6-hexanediol, 2,2-bis(4-hydroxyphenyl)propane, and bis(4-hydroxybenzene)stubble. Preferably, the diol is ethylene glycol.

Referring to FIG. 1 again, to enable the impact-resistant polyester material 100 to have high impact resistance, the toughening agent 2 (also called an impact-resistant modifier) is added into the impact-resistant polyester material 100, and the toughening agent 2 is dispersed in the polyester resin matrix material 1. In terms of material types, the toughening agent 2 is a polyolefin elastomer (POE), which is also called a polyolefin thermoplastic elastomer. The toughening agent 2 dispersed in the polyester resin matrix material 1 can be used to improve the impact strength of the impact-resistant polyester material 100.

In terms of content range, based on the total weight of the impact-resistant polyester material 100, a content range of the toughening agent 2 is preferably between 5 wt. % and 15 wt. %, and more preferably between 7-10 wt. %.

According to the above configuration, the impact-resistant polyester material 100 can have high impact resistance through the addition of the toughening agent 2. If the content of the toughening agent 2 is less than a lower limit of the above content range, the impact-resistant polyester material 100 will not have sufficient impact strength and cannot be applied to products with high impact resistance requirements. Conversely, if the content of the toughening agent 2 is greater than an upper limit of the above-mentioned content range, the toughening agent 2 will not be uniformly dispersed in the polyester resin matrix material 1. Accordingly, aggregation or precipitation of the toughening agent 2 may occur, thereby affecting formability of a final product and affecting performance of the impact strength.

From another perspective, one of the objectives of the present disclosure is to improve the impact strength of polyester materials, so as to enable the polyester materials to have high impact strength, high rigidity, and low material cost at the same time. In order to achieve the foregoing objective, the impact-resistant polyester material 100 of the present embodiment adopts the polyolefin elastomer (POE) as a toughening agent (also called an impact-resistant modifier).

Compared with an acrylic elastomer or a polyester elastomer, the polyolefin elastomer (POE) has a better intrinsic toughness and a lower material price. Therefore, an application of the polyolefin elastomer for improving the impact strength of the polyester materials has considerable advantages. However, compatibility between the polyolefin elastomer and the polyester material is not good. If only the polyolefin elastomer is directly mixed with the polyester material by way of an additive modification method, the polyolefin elastomer is easy to agglomerate, and the impact strength of the polyester material cannot be significantly improved.

Accordingly, a key technology of the present disclosure is to adjust a dispersed particle size of the polyolefin elastomer in the polyester material to be between 0.5 micrometers and 1.5 micrometers, and preferably between 0.5 micrometers and 1.2 micrometers, through compatibility modification, viscosity matching, and a kneading dispersion treatment between the polyolefin elastomer and the polyester material. Within the dispersed particle size, the impact-resistant polyester material 100 of the present embodiment can achieve characteristics of high impact resistance.

More specifically, the compatibilizing agent (not shown in the drawings) is dispersed in the polyester resin matrix material 1. The compatibilizing agent is configured to assist in improving the compatibility between the toughening agent 2 and the polyester resin matrix material 1.

In terms of material types, the compatibilizing agent is a polyolefin elastomer compatibilizing agent. In particular, the compatibilizing agent is at least one of a polyolefin elastomer grafted with glycidyl methacrylate (POE-g-GMA) and a polyolefin elastomer grafted with maleic anhydride (POE-g-MAH). Preferably, the compatibilizing agent is the polyolefin elastomer grafted with glycidyl methacrylate (POE-g-GMA).

Furthermore, the compatibilizing agent is configured to assist the toughening agent 2 to be dispersed into the polyester resin matrix material 1 with a particle size between 0.5 micrometers and 1.5 micrometers, so that the impact-resistant polyester material 100 has an impact strength of not less than 20 kg-cm/cm. In other words, the compatibilizing agent can effectively improve the compatibility and the dispersibility of the toughening agent 2 in the polyester resin matrix material 1. Accordingly, the toughening agent 2 can be dispersed into the polyester resin matrix material 1 with a smaller particle size, and is less likely to agglomerate.

In an exemplary embodiment of the present disclosure, the toughening agent 2 is dispersed into the polyester resin matrix material 1 with a particle size of between 0.5 micrometers and 1.2 micrometers. The impact strength of the impact-resistant polyester material 100 is between 28 kg-cm/cm and 50 kg-cm/cm, and is more preferably between 30 kg-cm/cm and 45 kg-cm/cm.

In terms of content range, based on the total weight of the impact-resistant polyester material 100, a content range of the compatibilizing agent is preferably between 2 wt. % and 15 wt. %.

According to the above configuration, the compatibilizing agent can effectively assist the toughening agent 2 to be dispersed into the polyester resin matrix material 1 with a smaller particle size. If the content of the compatibilizing agent is lower than a lower limit of the above content range, the compatibilizing agent cannot effectively assist the toughening agent 2 to be dispersed into the polyester resin matrix material 1 with a smaller particle size, and an auxiliary effect provided by the compatibilizing agent is poor. Conversely, if the content of the compatibilizing agent is higher than an upper limit of the above content range, the compatibilizing agent may affect formability of the polyester material, and an aggregation or precipitation phenomenon may occur.

Furthermore, the content range of the toughening agent 2 and the content range of the compatibilizing agent have a matching relationship there-between. Specifically, the content range of the toughening agent 2 is not less than the content range of the compatibilizing agent. Preferably, a weight ratio of the toughening agent 2 relative to the compatibilizing agent ranges from 1:1 to 4:1. More preferably, the weight ratio of the toughening agent 2 relative to the compatibilizing agent ranges from 1:1 to 2:1.

In terms of additives, the impact-resistant polyester material 100 further includes an antioxidant and a slip agent dispersed in the polyester resin matrix material 1. Based on the total weight of the impact-resistant polyester material being 100 wt. %, a content range of the antioxidant is between 0.1 wt. % and 1.0 wt. %, and a content range of the slip agent is between 0.1 wt. % and 1.0 wt. %.

In terms of material types, the antioxidant is at least one material selected from a group consisting of a phenolic antioxidant, a phosphorous acid antioxidant, and a hindered phenolic antioxidant. The slip agent is at least one material selected from a group consisting of silicon dioxide, stearic acid, polyethylene wax, stearates, fatty acid esters, and composite slip agents, but the present disclosure is not limited thereto. In terms of usage, the antioxidant is used to improve an oxidation resistance of the polyester material 100, and the slip agent is used to reduce a coefficient of friction or stickiness on a surface of the polyester material 100.

In an embodiment of the present disclosure, a molecular structure of the toughening agent 2 is all polyolefin elastomer (POE). A molecular structure of the compatibilizing agent has a main chain and a side chain, and the main chain is the polyolefin elastomer (POE). Therefore, the compatibilizing agent can have excellent compatibility with the toughening agent 2 through its main chain due to the same molecular structure.

In an embodiment of the present disclosure, the compatibilizing agent is further defined as a polyolefin elastomer grafted with glycidyl methacrylate (POE-g-GMA). The molecular structure of the compatibilizing agent has a main chain and a side chain melt-grafted with the main chain, the main chain is the polyolefin elastomer (POE), and the side chain is the glycidyl methacrylate (GMA).

The glycidyl methacrylate can produce a ring-opening reaction during a mixing process, and an epoxy group in the glycidyl methacrylate can chemically react with an ester group in a molecular structure of the polyester resin matrix material after the ring-opening reaction, so that the toughening agent 2 is more uniformly dispersed in the polyester resin matrix material 1.

In an embodiment of the present disclosure, to improve the dispersibility of the toughening agent 2 (POE) in the polyester resin matrix material 1, the impact-resistant polyester material 100 may be formed into a polyester master-batch by extrusion granulation, so that the toughening agent 2 is dispersed in the polyester material for a first time. The polyester master-batch is then molded into a molded product (such as an injection part or an extruded part) by injection molding or extrusion molding, so that the toughening agent 2 is dispersed in the polyester material for a second time.

In an embodiment of the present disclosure, to improve the dispersibility and the compatibility of the toughening agent 2 (POE) in the polyester resin matrix material 1, a melt flow index of the polyester resin matrix material 1 and a melt flow index of the toughening agent 2 have a matching relationship there-between.

Specifically, the polyester resin matrix material 1 (PET) has a first melt flow index, and the toughening agent 2 (POE) has a second melt flow index. The first melt flow index of the polyester resin matrix material 1 is between 55 g/10 min and 65 g/10 min. The second melt flow index of the toughening agent 2 is between 75% and 125% of the first melt flow index of the polyester resin matrix material 1, and is preferably between 80% and 120%. For example, the first melt flow index of the polyester resin matrix material 1 is about 60 g/10 min, and the second melt flow index of the toughening agent 2 (POE) is about 50 g/10 min.

It should be noted that the “melt flow index (MI)” referred herein can also be called a melt flow rate (MFR). The melt flow index refers to a weight of a polymer melt that passes through a standard die (2.095 mm) every ten minutes under a certain temperature and a certain load.

In an embodiment of the present disclosure, the polyester resin matrix material 1 is a continuous phase, and the toughening agent 2 is a dispersed phase dispersed in the continuous phase. The dispersed phase and the continuous phase interact with each other, so that a material surface of the impact-resistant polyester material forms a sea-island structure.

It is worth mentioning that the above-mentioned “sea-island structure” refers to poor compatibility between two high molecular weight polymers (i.e., the polyester resin matrix material 1 and the toughening agent 2). After the two high molecular weight polymers are blended with each other, a heterogeneous system is formed. The dispersed phase is dispersed in the continuous phase, which is like small islands scattered in the ocean. By using a mechanism of two-phase interaction of the sea-island structure, properties of a polymer can be improved.

In an embodiment of the present disclosure, the impact-resistant polyester material 100 can be molded into molded products (such as injection parts or extruded parts) by injection molding or extrusion molding. Some examples of the molded products may include luggage cases, safety helmets, electronic casings, food trays, and electronic and automotive decorative films. Generally, after injection molding or extrusion molding, the impact-resistant polyester material 100 has a thickness ranging from 800 μm to 4,000 μm.

According to the above configuration, the impact-resistant polyester material 100 has excellent physical and chemical properties. Specifically, the impact-resistant polyester material meets at least one of the following conditions: (i) the polyester material has an impact strength ranging from 20-50 kg-cm/cm; (ii) the polyester material has a density ranging from 1.15-1.30 g/cm³; (iii) the polyester material has a tensile strength ranging from 38-50 MPa; (iv) the polyester material has a bending strength ranging from 65-75 MPa; (v) the polyester material has a bending modulus ranging from 1,800-2,200 MPa; (vi) the polyester material has a heat distortion temperature (HDT) ranging from 55-80° C.; (vii) the polyester material has a shrinkage ranging from 0.7-1.0; and (viii) the polyester material has an HB rating in a UL94 plastic flammability standard.

### Beneficial Effects of the Embodiments

In conclusion, in the impact-resistant polyester material provided by the present disclosure, by virtue of “the toughening agent being dispersed in the polyester resin matrix material, and the toughening agent being a polyolefin elastomer (POE)” and “the compatibilizing agent being dispersed in the polyester resin matrix material, the compatibilizing agent being configured to assist in improving a compatibility between the toughening agent and the polyester resin matrix material; in which the compatibilizing agent being at least one of a polyolefin elastomer grafted with glycidyl methacrylate (POE-g-GMA) and a polyolefin elastomer grafted with maleic anhydride (POE-g-MAH)” and “the compatibilizing agent being configured to assist the toughening agent to be dispersed into the polyester resin matrix material with a particle size between 0.5 micrometers and 1.5 micrometers”, an impact strength of the polyester material can be greatly improved, thereby enhancing the application value of the polyester material.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An impact-resistant polyester material, comprising:
a polyester resin matrix material;
a toughening agent dispersed in the polyester resin matrix material, wherein the toughening agent is a polyolefin elastomer (POE); and
a compatibilizing agent dispersed in the polyester resin matrix material, wherein the compatibilizing agent is configured to assist in improving compatibility between the toughening agent and the polyester resin matrix material; wherein the compatibilizing agent is at least one of a polyolefin elastomer grafted with glycidyl methacrylate (POE-g-GMA) and a polyolefin elastomer grafted with maleic anhydride (POE-g-MAH);
wherein the compatibilizing agent is configured to assist the toughening agent to be dispersed into the polyester resin matrix material with a particle size between 0.5 micrometers and 1.5 micrometers, so that the impact-resistant polyester material has an impact strength of not less than 20 kg-cm/cm.

2. The impact-resistant polyester material according to claim 1, wherein, based on a total weight of the impact-resistant polyester material being 100 wt. %, a content range of the polyester resin matrix material is between 70 wt. % and 95 wt. %, a content range of the toughening agent is between 5 wt. % and 15 wt. %, and a content range of the compatibilizing agent is between 2 wt. % and 15 wt. %.

3. The impact-resistant polyester material according to claim 2, wherein, based on the total weight of the impact-resistant polyester material being 100 wt. %, the content range of the polyester resin matrix material is between 70 wt. % and 90 wt. %, the content range of the toughening agent is between 7 wt. % and 10 wt. %, and the content range of the compatibilizing agent is between 2 wt. % and 5 wt. %.

4. The impact-resistant polyester material according to claim 2, wherein the content range of the toughening agent is not less than the content range of the compatibilizing agent, and a weight ratio of the toughening agent relative to the compatibilizing agent ranges from 1:1 to 4:1.

5. The impact-resistant polyester material according to claim 1, further comprising: an antioxidant and a slip agent dispersed in the polyester resin matrix material, wherein, based on a total weight of the impact-resistant polyester material being 100 wt. %, a content range of the antioxidant is between 0.1 wt. % and 1.0 wt. %, and a content range of the slip agent is between 0.1 wt. % and 1.0 wt. %.

6. The impact-resistant polyester material according to claim 1, wherein an entire molecular structure of the toughening agent is the POE, a molecular structure of the compatibilizing agent has a main chain and a side chain, and the main chain is the POE.

7. The impact-resistant polyester material according to claim 1, wherein the compatibilizing agent is further defined as the POE-g-GMA, a molecular structure of the compatibilizing agent has a main chain and a side chain melt-grafted with the main chain, the main chain is the POE, and the side chain is the GMA; wherein the GMA is able to produce a ring-opening reaction during a mixing process, and an epoxy group in the GMA is able to chemically react with an ester group in a molecular structure of the polyester resin matrix material after the ring-opening reaction, so that the toughening agent is dispersed in the polyester resin matrix material.

8. The impact-resistant polyester material according to claim 1, wherein the polyester resin matrix material has a first melt flow index, and the toughening agent has a second melt flow index; wherein the first melt flow index of the polyester resin matrix material is between 55 g/10 min and 65 g/10 min, and the second melt flow index of the toughening agent is between 75% and 125% of the first melt flow index of the polyester resin matrix material.

9. The impact-resistant polyester material according to claim 1, wherein the polyester resin matrix material is a continuous phase, and the toughening agent is a dispersed phase dispersed in the continuous phase; wherein the dispersed phase and the continuous phase interact with each other, so that a material surface of the impact-resistant polyester material forms a sea-island structure.

10. The impact-resistant polyester material according to claim 1, wherein the impact-resistant polyester material meets at least one of following conditions:
(i) having an impact strength between 20 kg-cm/cm and 50 kg-cm/cm;
(ii) having a density between 1.15 g/cm³ and 1.30 g/cm³;
(iii) having a tensile strength between 38 MPa and 50 MPa;
(iv) having a bending strength between 65 MPa and 75 MPa;
(v) having a bending modulus between 1,800 MPa and 2,200 MPa;
(vi) having a heat distortion temperature between 55° C. and 80° C.;
(vii) having a shrinkage between 0.7 and 1.0; and
(viii) having an HB rating in a UL94 plastic flammability standard.
